(19) United States
(12) Patent Application Publication
(10) Pub. No.: US 2005/0133242 A1
(43) Pub. Date: Jun. 23, 2005

(54) Fire barrier for openings in walls or the like, comprising multiple frames for cable entries

(76) Inventor: Tomas Kreutz, Lyckeby (SE)

Correspondence Address: Steven S. Payne;Suite 1005, 1101 17th St. N.W., Washington, DC, 20036, US

(21) Appl. No.: 10/974,686

(22) Filed: Oct. 28, 2004

(30) Foreign Application Priority Data
May 8, 2002 (SE) 0201386-0
Apr. 23, 2003 (WO) PCT/SE03/00650

(51) Int. Cl. H02G 3/18

(52) U.S. Cl. 174/65 G

(57) ABSTRACT

A fire protection means is disclosed for a frame for cable entries, pipe penetration and the like. The frame comprises an outer frame to be mounted in a wall or the like. Furthermore, the frame has one or more inner frames, having one or more cable entries or the like. An extension is arranged in connection with the frame on at least one side of the wall. The extension is furnished with the fire protection means.

### TECHNICAL FIELD

The present invention concerns a fire protection means for a frame for cable entries, a pipe penetration or the like.

### PRIOR ART

When cables, pipes or the like are to be fed through walls, ceilings, roofs, tops or floors of buildings or the like, there are often governmental demands regarding fire protection. Such demands normally stipulates that a pipe penetration, cable entry or the like should withstand fire for a stipulated period of time, without risking that the fire is spread to the other side of the wall etc. Depending on type of building the demands may be differently severe. Frames of this kind may also be used in containers, cabinets etc.

Each frame may receive a number of different cables and/or pipes. The cables may be for electricity, communication, computers etc. and the pipes may be for different gases or liquids, such as water, compressed air, hydraulic fluid and cooking gas.

### SUMMARY OF THE INVENTION

One object of the present invention is that the fire protection means should be relatively flexible and thus, be able to adapt to different types of frames for cable entries, pipe penetrations or the like. It is also an object that the fire protection means should function well independently of the number of cables, pipes or the like that are fed through a wall or the like.

A further object is that the temperature in case of a fire or other heat exposure is kept relatively low at the non-exposed side of the wall etc. Still a further object is that it shall be relatively easy to install cables, pipes or the like in the wall etc. both before and after a possible fire or other heat exposure.

It is also one object of the present invention that the fire protection means should be possible to retrofit, i.e. to furnish existing frames with a fire protection means according to the present invention. Thus, it should also be possible to mount the fire protection means over existing cables etc.

According to the present invention the fire protection means is received in an extension of an outer frame, through which the cables, pipes etc are to be fed. The extension extends from the frame on at least one side of the wall or the like of the building etc.

Further objects and advantages of the present invention will be obvious for a person skilled in the art, when reading the detailed description below of one presently preferred embodiment.

### BRIEF DESCRIPTION OF THE DRAWINGS

The invention will be described further below, by way of an example and with reference to the enclosed drawings. In the drawings:

FIG. 1 is a perspective view of a wall receiving a frame, which frame is furnished with fire protection means according to the present invention, and

FIG. 2 is a perspective view of the frame of FIG. 1, viewed from the opposite side of the wall.

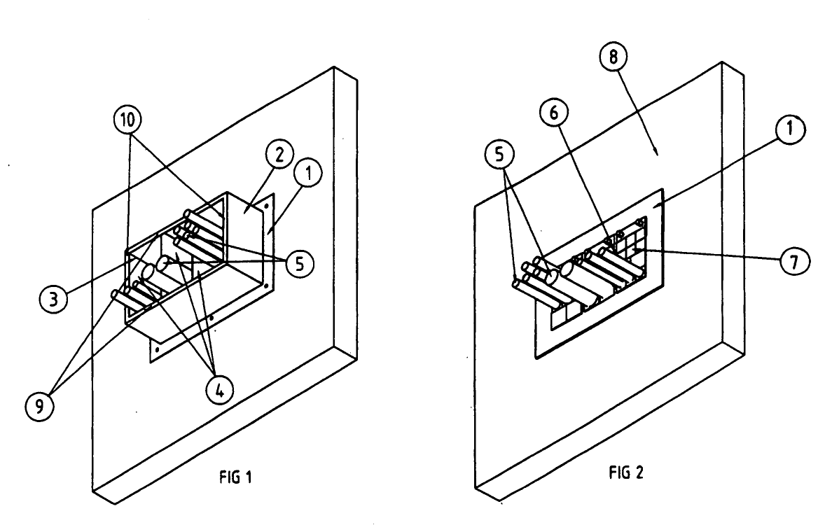

### DETAILED DESCRIPTION OF A PREFERRED EMBODIMENT

The expressions “horizontal”, “vertical” and similar expressions, as used in this description, are with reference to the directions as shown in the FIGS. A person skilled in the art realises that the frame for cable entries and the like may have any orientation. Thus, the frame may be received in walls, ceilings or floors.

According to the shown embodiment of the present invention an outer frame 1 for cable entries, pipe penetrations etc. is mounted in an opening of a wall 8. The outer frame 1 has an extension 2. The extension 2 is formed of two horizontal walls 9 and two vertical walls 10. Thus, the extension 2 has a general rectangular form in the shown embodiment and extends a distance on one side of the wall 8. A person skilled in the art realises that the outer frame 1 as well as the extension 2 may have any general form, without departing from the scope of the present invention. The extension 2 is either a separate part fixed to the outer frame 1, or the wall 8, or is an integrated part of the outer frame 1. If the extension 2 is a separate part any fixation means may be used for the fixation with the outer frame 1. Such fixation means may be screws, rivets, welding, soldering, glue etc.

In other embodiments (not shown) fire protection means according to the present invention are arranged on both sides of the wall 8 or the like. In a further alternative embodiment the outer frame 1 is arranged on one side of the wall 8 or the like, while the extension 2 including the fire protection means is arranged on the other side. Normally, the walls 9, 10 of the extension 2 are fixed to each other in a releasable way, which means that the extension 2 may be mounted after the cables, pipes or the like. For such a mounting after the cables etc, at least one of the walls 9, 10 of the extension 2 is first disassembled and the rest of the extension is brought over the cables. The next step is to assemble the extension 2 once again by adding the dismounted wall or walls 9, 10. At the same time the extension 2 is mounted to the frame 1 or wall 8.

The outer frame 1 is to receive one or more inner frames 6. The inner frames 1 has one or more cable entries 7, pipe penetrations etc. for receiving cables 5, pipes or the like in a sealed way. As the exact form of the cable entries 7 etc. is of no importance for the present invention, they will not be described extensively here. The inner frames 6 and the cable entries 7 received in said inner frames 6, normally does not extend into the extension 2 of the outer frame 1. The extension 2 has a through opening 3. In the opening 3 of the extension 2 a number of sheets 4 of heat expandable material are received.

The sheets 4 of heat expandable material are received on walls, by which a number of compartments are formed in the extension 2. The walls forming the compartments extend across the opening 3 of the extension 2, i.e. intumescent material, for fire protection is well known in the art and the exact material is not decisive for the invention, as long as the material expand enough to fulfil the demands as stated below. In this description the expression “heat expandable material” is used in view of simplicity.

Normally sheets 4 of heat expandable material are received both on possible walls crossing the opening 3 of the extension 2 directed away from the wall 8 and on the vertical and horizontal walls 9, 10 of the extension 2. It is also possible to replace the sheets 4 on the inner walls of the extension 2 with coatings of the heat expandable material. The heat expandable material may also be applied in the form of paint. Thus, in this case the inside walls of the extension 2 and/or the possible walls crossing the opening of the extension 2 are coated with the heat expandable material. By this embodiment each cable 5 or the like will be surrounded by heat expandable material on four sides in the extension 2.

The cables 5, pipes or the like received in the inner frames 6 will go between the sheets 4 of expandable material placed in the extension 2 of the outer frame 1. The extension 2 is normally to be directed towards that side of the wall 8 on which the risk of fire is greatest. As indicated above it is also possible to place an extension 2 on each side of the wall 8. This may be done if there is a potential risk of fire or extensive heat on both sides of the wall 8.

When using the present invention the cables 5, pipes or the like will be mounted in the same way as previously done. The only difference is that the cables 5 etc., also are brought through the extension or extensions 2 and between the sheets 4 of expandable material.

In case of extensive heat, such as in case of fire, the sheets 4 of expandable material will expand. The material will expand and totally fill out the extension 2 of the outer frame 1. Possible soft tubes or the like may collapse of the pressure of the expanded material, whereby said tubes will be sealed off hindering further transportation of possibly deleterious material. Furthermore, the expanded material will absorb the heat and thus, contribute to a lower temperature of the cables 5 etc. and other parts on that side of the wall 8 not directly exposed to the fire or other heat source. Depending on the extent of damage it is often possible to only have to replace the cables 5 etc. and the sheets 4 of heat expandable material after a fire. Thus, it will be relatively easy to replace the damaged parts at a relatively low cost.

1-11. (canceled)

12. A fire protection means in form of an extension, for a frame for cable entries or pipe penetrations, said frame comprises an outer frame to be mounted in a wall and one or more inner frames, having one or more cable entries, wherein the extension is mounted on the wall or outer frame on at least one side of the wall, and the extension is furnished with fire protection parts in the form of one or more sheets of heat expandable material.

13. The fire protection means of claim 12, wherein the extension has the form of an open frame, having walls forming a through opening through which cables or the like are to be fed.

14. The fire protection means of claim 13, wherein several compartments are formed in the through opening by means of walls extending across said opening.

15. The fire protection means of claim 12, wherein the extension is mounted on the outer frame by fastening means.

16. The fire protection means of claim 12, wherein the outer frame is mounted on one side of the wall and the extension on the other side.

17. The fire protection means of claim 13, wherein the one or more sheets of heat expandable material are placed extended between two opposing walls of the extension.

18. The fire protection means of claim 13, wherein heat expandable material is placed on the inside of the walls of the extension.

19. The fire protection means of claim 13, wherein the cables or pipes are surrounded by heat expandable material on four sides in the extension.
